(19) United States
(12) Patent Application Publication
(10) Pub. No.: US 2006/0092491 A1
(43) Pub. Date: May 4, 2006

(54) Optical pattern projection for lighting, marking and demarcation enhancement

(75) Inventor: Sean Xiaolu Wang, Wilmington, DE (US)

Correspondence Address: BLANK ROME LLP, 600 NEW HAMPSHIRE AVENUE, N.W., WASHINGTON, DC, 20037, US

(73) Assignee: BWT Property, Inc., Newark, DE (US)

(21) Appl. No.: 11/260,667

(22) Filed: Oct. 28, 2005

Related U.S. Application Data
(60) Provisional application No. 60/622,609, filed on Oct. 28, 2004.

(51) Int. Cl. G02B 26/08

(52) U.S. Cl. 359/196

(57) ABSTRACT

An optical pattern projection system and method use lasers and diffractive optical components to provide illumination and demarcation for airports, helipads, waterways, emergence route, pedestrian cross, as well as aid for search and rescue operations. The diffractive optical components produce an illumination pattern in the spatial domain and can use either passive or active optical elements.

### REFERENCE TO RELATED APPLICATION

The present application claims the benefit of U.S. Provisional Patent Application No. 60/622,609, filed Oct. 28, 2004, whose disclosure is hereby incorporated by reference in its entirety into the present disclosure.

### FIELD OF INVENTION

This invention generally relates to a light projection apparatus, and more specifically to a light projection apparatus employing lasers and diffractive optical components for applications in lighting, marking and demarcation enhancement.

### BACKGROUND OF THE INVENTION

The utilization of a laser to generate a uniformly illuminated line for lighting, marking and demarcation can date back to the early 1970s, wherein Veres described a gas laser based illumination system for providing center and edge stripes for an airport runway in U.S. Pat. No. 3,866,032. The advantages of laser based lighting and marking apparatus include high brightness, good beam quality, long lifetime and low power consumption.

Later development in this field can be found in U.S. Pat. No. 4,700,912 to Corbett, U.S. Pat. Nos. 6,007,219 and 6,688,755 to O'Meara, and U.S. Pat. No. 6,320,516 to Reason. In these references, a conventional refractive optical component, such as a glass plano-convex cylindrical lens, is used to convert the laser output from a spot into an illumination line.

To produce a complex pattern, such as a multi-stripe start line for an airport runway, multiple laser sources or refractive lenses have to be used, which adds to possibility of failure to the whole system. Certain complicated patterns, including some signs, are impossible to generate by conventional refractive optical components.

### SUMMARY OF THE INVENTION

It is thus an object of the present invention to avoid the above-noted deficiencies of the prior art.

In particular, it is an object of the present invention to allow the creation of more complicated patterns than have been possible in the prior art.

It is another object of the present invention to avoid the use of unnecessarily complicated systems and their failure rate.

To achieve the above and other objects, the present invention uses diffractive optical components for optical pattern projection for lighting, marking and demarcation enhancement.

The diffractive optical component is a beam shaping and steering device capable of modulating the phase or amplitude of the wavefront of an optical beam, such as that from a laser or a light emitting diode (LED). The phase or amplitude modulation is performed in a micro scale with a spatial dimension much smaller than the size of the optical beam. As a result, the modulated optical beam can produce any complicated illumination pattern on a target plane. The diffractive optical component can be fabricated using holographic recording methods or wafer-based micro-fabrication techniques that are generally adopted in current semiconductor industry. The diffractive efficiency of the component can reach a level of >90%.

It is yet another object of the present invention to provide a yellow colored diode-pumped solid-state laser (DPSSL) for lighting, marking and demarcation enhancement. Previously demonstrated yellow laser airport lighting apparatuses for hold-line demarcation utilize either a He—Ne gas laser, which is limited by available power, or a composite yellow colored laser beam generated by combining a green colored DPSSL at 532 nm and a red colored diode laser at 635-670 nm, which suffers from a color uniformity problem. By adopting dual infrared wavelength generation and nonlinear frequency mixing technology, this invention discloses a true yellow colored DPSSL at wavelength regime of 560-600 nm for lighting, marking and demarcation enhancement.

### BRIEF DESCRIPTION OF THE DRAWINGS

Preferred embodiments of the present invention will be set forth in detail with reference to the drawings, in which:

FIG. 1 illustrates the mechanical layout of an exemplary optical pattern projection apparatus;

FIG. 2 illustrates one operation mode of the optical pattern projection apparatus, wherein a multi-stripe line pattern is projected on an airport runway;

FIG. 3 illustrates the mechanism for complex illumination pattern generation utilizing micro-scale optical phase modulation;

FIG. 4(a) illustrates a dynamically reconfigurable diffractive optical component employing a liquid crystal modulator; and

FIG. 4(b) illustrates a dynamically reconfigurable diffractive optical component employing micro-electro-mechanical systems (MEMS).

### DETAILED DESCRIPTION OF THE PREFERRED EMBODIMENTS

Preferred embodiments of the present invention will now be set forth in detail with reference to the drawings.

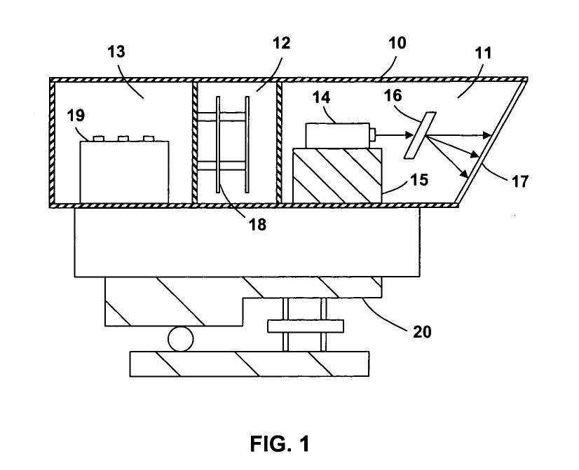

In one preferred embodiment of the current invention as shown in FIG. 1, the optical pattern projection apparatus comprises a waterproof housing 10 with three compartments, i.e., a laser compartment 11, an electronic compartment 12, and an optional battery compartment 13. The laser compartment 11 further comprises a true yellow colored DPSSL 14 mounted on a heat sink 15, and a diffractive optical component 16 to modulate the phase/amplitude of the laser beam in spatial domain and produce a desired illumination pattern on the target surface. The modulated laser beam is delivered to the target surface through a transparent window 17. Depending on the application requirements, a lens or a group of lenses may be inserted between the laser 14 and the diffractive optical component 16 for beam expansion and collimation.

The DPSSL 14 comprises a laser crystal, such as Nd:YVO₄, pumped by an 808 nm laser diode. The laser crystal produces two infrared laser beams at 1064 nm and 1342 nm, respectively. A nonlinear crystal, such as KTP, is employed to mix the two infrared laser beams and produce a yellow laser beam at 593.5 nm.

The electronic compartment 12 comprises one or more electronic circuit boards 18 to drive the DPSSL and control its output intensity. An optional rechargeable battery 19 in the battery compartment 13 is used to provide power to the electronic circuit boards 18. The housing 10 is mounted on a mounting unit 20, which is adjustable in height and elevation angle to control the pattern projection manner.

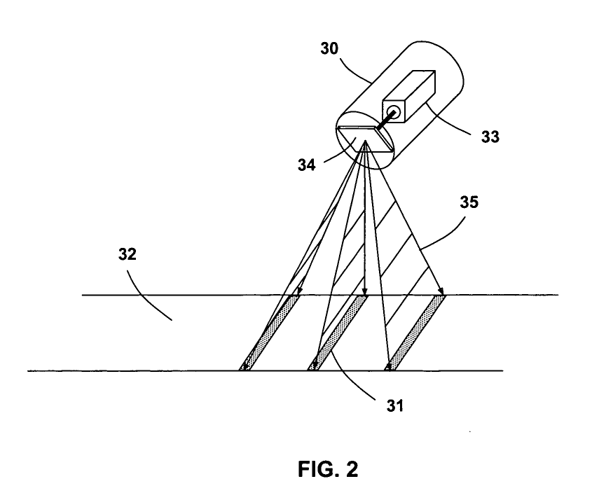

One exemplary operation mode of the optical pattern projection apparatus is illustrated in FIG. 2, wherein the optical pattern projection apparatus 30 is used to produce a multi-stripe line pattern 31 on an airport runway 32. In this scheme, the elevated optical pattern projection apparatus 30 is placed on one side of the runway. The laser beam generated by the DPSSL 33 is diffracted and expanded by the diffractive optical component 34 (corresponding to the component 16 of FIG. 1) into multiple sections 35 and projected onto the surface of the runway to form the multi-stripe line pattern 31. Except as explicitly described herein, the disclosure of FIG. 1 applies to the embodiment of FIG. 2.

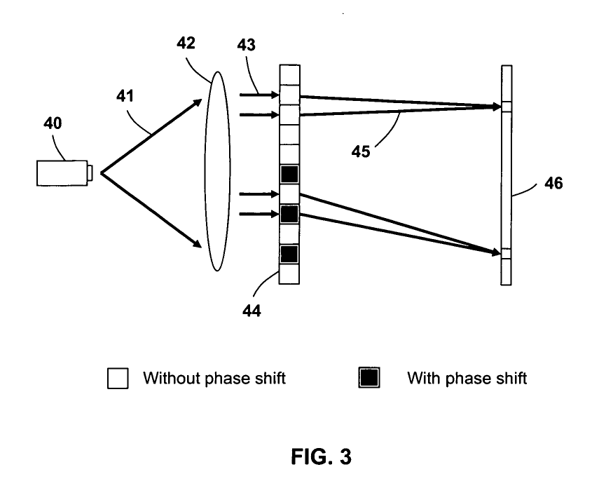

A more detailed illustration of the optical pattern projection mechanism is shown in FIG. 3, in which a diffractive optical component with binary phase modulation is employed. In FIG. 3, the laser beam 41 produced by a laser 40 is first collected and collimated by a lens 42. The collimated laser beam 43 is then delivered to a diffractive optical component 44 (corresponding to the component 16 of FIG. 1) with micro-scale thickness or refractive index modulation, which induces phase modulation on the wavefront of the output laser beam 45. Except as explicitly described herein, the disclosure of FIG. 1 applies to the embodiment of FIG. 3.

For reasons of simplicity, the phase modulation is illustrated in a binary mode in FIG. 3 (with a phase shift value of either 0 or π), although the present invention is not limited to such a binary mode. Thus, the light emitted from adjacent phase modulation elements will interfere either constructively or destructively to form bright and dark patterns on the target plane 46. The diffractive optical component 44 can be viewed as a beam shaping and steering element, which adjusts the propagation direction and profile of the laser beam by varying the phase of its wavefront.

In real applications, the diffractive optical component can adopt grayscale phase modulation as well as amplitude modulation to produce even more complicated illumination patterns. It can also work in a reflection mode where the output optical beam propagates in opposite direction of the input optical beam. With the rapid development of micro-fabrication technology, the spatial resolution of the diffractive optical component can reach the same order as the laser wavelength. Potentially, any desirable illumination patterns, such as numbers, characters, and figures, can be generated.

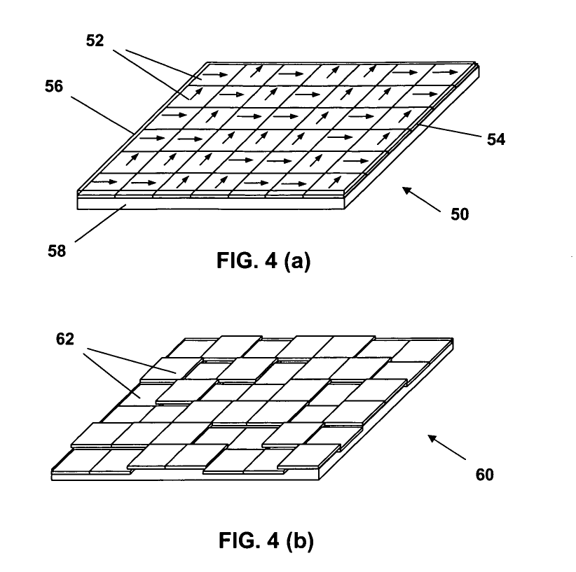

In another embodiment of the current invention, the diffractive optical component is dynamically reconfigurable to produce different illumination patterns with the same laser module. One example is a liquid crystal based dynamic spatial phase/amplitude modulator configured as an array 50 of elements 52, as illustrated in FIG. 4(a). Nematic or ferroelectric liquid crystal 54 is injected between two layers of electrodes 56, 58. One layer of electrodes 58 is micro-patterned to form an electrode array. By applying different voltages on the electrodes, the orientation of the liquid crystal molecules will change correspondingly. Thus, the refractive index or absorption in each element 52 can be adjusted to modulate the wavefront of the optical beam. The desired pattern is then generated in a similar way as described in the first embodiment. The voltages applied on the electrodes can be dynamically reconfigured to generate different patterns.

In another example of the embodiment, as illustrated in FIG. 4(b), an array of micro-electro-mechanical systems (MEMS) mirrors 62 is used instead of liquid crystal modulator to implement an array of elements 60. The phase or amplitude modulation is produced by varying the positions or tilt angles of the micro-mirrors 62.

The array 50 or 60 can be used in place of the element 16 of FIG. 1.

While some preferred embodiments of the present invention have been set forth in detail, those skilled in the art who have reviewed the present disclosure will readily appreciate that other embodiments can be realized within the scope of the invention. For example, the diffractive optical component may utilize both phase and amplitude modulation. Conventional refractive optical components may be used in combination with the diffractive optical component for light beam control. The dynamic spatial phase (amplitude) modulator may be realized using other technologies. The light source is not limited to diode-pump solid-state lasers. Therefore, the present invention should be construed as limited only by the appended claims.

I claim:

1. An optical pattern projection apparatus for lighting, marking and demarcation enhancement, the optical pattern projection apparatus comprising:
a. at least one optical light source for producing at least one light beam; and
b. at least one diffractive optical component for modulating at least one of a phase and an amplitude of said light beam to produce an illumination pattern for said lighting, marking and demarcation enhancement.

2. The optical pattern projection apparatus of claim 1, wherein the optical light source comprises a laser.

3. The optical pattern projection apparatus of claim 2, wherein the laser is a single wavelength, diode-pumped solid-state laser emitting in the wavelength regime of 560-600 nm.

4. The optical pattern projection apparatus of claim 1, wherein the optical light source comprises a light emitting diode (LED) or LED array.

5. The optical pattern projection apparatus of claim 1, wherein the diffractive optical component is fabricated on an optical material with thickness, refractive index and/or absorption modulation in a spatial domain, and wherein a spatial scale of said modulation is significantly smaller than the diameter of the light beam and on an order of magnitude of a wavelength of the light source.

6. The optical pattern projection apparatus of claim 1, wherein the diffractive optical component comprises an active material, and wherein a refractive index or absorption of said active material is dynamically reconfigurable in a spatial domain.

7. The optical pattern projection apparatus of claim 6, wherein the active material comprises a liquid crystal material.

8. The optical pattern projection apparatus of claim 1, wherein the diffractive optical component comprises a mirror array comprising a plurality of mirrors, and wherein a position or tilt angle of said mirrors is dynamically reconfigurable in a spatial domain.

9. The optical pattern projection apparatus of claim 8, wherein the mirror array comprises a micro-electro-mechanical systems (MEMS) mirror array.

10. The optical pattern projection apparatus of claim 1, further comprising one or more refractive optical components to control said light beam.

11. A method for lighting, marking and demarcation enhancement, the method comprising:
a. producing at least one light beam;
b. using at least one diffractive optical component to modulate at least one of a phase and an amplitude of said light beam to produce an illumination pattern for said lighting, marking and demarcation enhancement; and
c. projecting said illumination pattern into an area in which said lighting, marking and demarcation enhancement is provided.

12. The method of claim 11, wherein said area is at an airport.

13. The method of claim 11, wherein said area is at a helipad.

14. The method of claim 11, wherein said area is at a waterway.

15. The method of claim 11, wherein said area is at an emergency route.

16. The method of claim 11, wherein said area is at a pedestrian crosswalk.

17. The method of claim 11, wherein the diffractive optical component is fabricated on an optical material with thickness, refractive index and/or absorption modulation in a spatial domain, and wherein a spatial scale of said modulation is significantly smaller than the diameter of the light beam and on an order of magnitude of a wavelength of the light beam.

18. The method of claim 11, wherein the diffractive optical component comprises an active material, and wherein a refractive index or absorption of said active material is dynamically reconfigurable in a spatial domain.

19. The method of claim 18, wherein the active material comprises a liquid crystal material.

20. The method of claim 11, wherein the diffractive optical component comprises a mirror array comprising a plurality of mirrors, and wherein a position or tilt angle of said mirrors is dynamically reconfigurable in a spatial domain.

21. The method of claim 20, wherein the mirror array comprises a micro-electro-mechanical systems (MEMS) mirror array.
